(19) United States
(12) Patent Application Publication
(10) Pub. No.: US 2021/0280184 A1
(43) Pub. Date: Sep. 9, 2021

(54) INFORMATION PROCESSING TERMINAL

(71) Applicant: TOSHIBA TEC KABUSHIKI KAISHA, Tokyo (JP)

(72) Inventors: Naoki SEKINE, Mishima Shizuoka (JP); Shogo WATADA, Sunto Shizuoka (JP)

(73) Assignee: TOSHIBA TEC KABUSHIKI KAISHA, Tokyo (JP)

(21) Appl. No.: 17/177,397

(22) Filed: Feb. 17, 2021

(30) Foreign Application Priority Data
Mar. 9, 2020 (JP) 2020-039616

(51) Int. Cl. G10L 15/22; G10L 15/02; G10L 15/10; G10L 25/51

(52) U.S. Cl. CPC G10L 15/22; G10L 15/02; G10L 2015/228; G10L 25/51; G10L 15/10

(57) ABSTRACT

According to one embodiment, there is provided an information processing terminal including a voice input device and a processor. The voice input device receives a voice input. The processor calculates feature data related to the voice input, determines whether the voice input device is blocked, based on the feature data calculated, and generates a notification that the voice input device is blocked according to a determination result indicating that the voice input device is blocked.

### CROSS-REFERENCE TO RELATED APPLICATION

This application is based upon and claims the benefit of priority from Japanese Patent Application No. 2020-039616, filed on Mar. 9, 2020, the entire contents of which are incorporated herein by reference.

### FIELD

Embodiments described herein relate generally to an information processing terminal.

### BACKGROUND

A portable terminal such as a tablet terminal (e.g., a tablet) that can be operated by voice input is widespread. Such a portable terminal is utilized in various places in order to enhance the convenience of a user.

For example, a technology has been developed in which a portable terminal is placed in a restaurant and enables an order to be placed by operating the portable terminal by voice input.

In general, the user tends to hold the portable terminal in his or her hands when operating the portable terminal by voice input.

However, when the user holds the portable terminal, the user may unintentionally block a microphone of the portable terminal with his/her finger or hand. For example, when the user uses a portable terminal placed in a store, since the user holds the portable terminal without worrying about the position of the microphone, the microphone is easily blocked. If the portable terminal cannot collect voice input with the microphone to the extent that the portable terminal can recognize the voice, the portable terminal may malfunction.

### DESCRIPTION OF THE DRAWINGS

FIG. 1 is an external view illustrating a terminal according to an embodiment;

FIG. 2 is a block diagram illustrating the terminal according to an embodiment;

FIG. 3 is a diagram illustrating a sound pressure level database according to an embodiment;

FIG. 4 is a flowchart illustrating a procedure of a sound pressure level calculation process by the terminal according to an embodiment;

FIG. 5 is a flowchart illustrating a procedure of an occlusion determination process by the terminal according to an embodiment;

FIG. 6 is a flowchart illustrating a procedure of a first occlusion determination process by the terminal according to an embodiment;

FIG. 7 is a table illustrating the first occlusion determination by the terminal according to an embodiment;

FIG. 8 is a graph illustrating the first occlusion determination by the terminal according to an embodiment;

FIG. 9 is a flowchart illustrating a procedure of a second occlusion determination process by the terminal according to an embodiment;

FIG. 10 is a table illustrating the second occlusion determination by the terminal according to an embodiment; and

FIG. 11 is a graph illustrating the second occlusion determination by the terminal according to an embodiment.

### DETAILED DESCRIPTION

Embodiments described herein provide a technique for improving the accuracy of determining whether a voice input unit (e.g., a voice input device) is blocked.

In general, according to an embodiment, there is provided an information processing terminal including a voice input unit (e.g., a voice input device), a calculation unit (e.g., a calculator), a determination unit (e.g., a detector), and a notification unit (e.g., a device configured to generate a notification). The voice input unit inputs voice. The calculation unit calculates feature data related to the voice input to the voice input unit. The determination unit determines whether or not the voice input unit is blocked, based on the feature data calculated by the calculation unit. The notification unit notifies that the voice input unit is blocked according to the determination result by the determination unit indicating that the voice input unit is blocked.

Hereinafter, embodiments will be described with reference to the accompanying drawings.

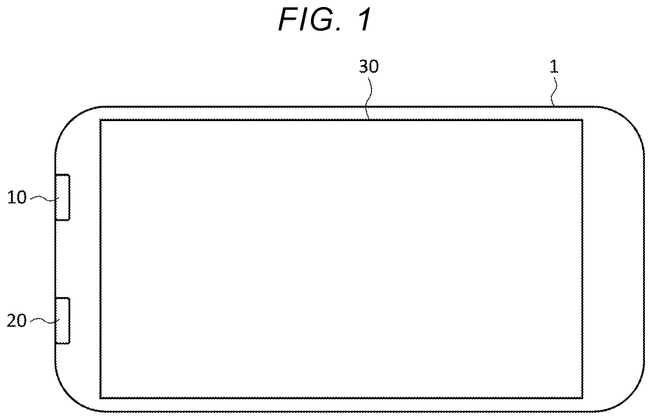

FIG. 1 is an external view illustrating a terminal 1.

The terminal 1 is a portable device that can be operated by voice input. For example, the terminal 1 is a tablet terminal but may be a smartphone or the like. For example, the terminal 1 is placed in a store such as a restaurant and enables an order by voice.

The terminal 1 includes a microphone 10, a speaker 20, and a display 30.

The microphone 10 is a device capable of receiving voices of a surrounding environment of the terminal 1. The voices input to the microphone 10 are sounds emitted in the environment in which the terminal 1 is placed and voices of persons in the surrounding environment in which the terminal 1 is placed. The sounds emitted in the surrounding environment in which the terminal 1 is placed include various sounds such as a contact sound of an object, an operating sound of a device, and music. The voice of a person in the surrounding environment where the terminal 1 is placed includes not only the voice of a user who uses the terminal 1 but also the voice of a person in the vicinity of the terminal 1. For example, the microphone 10 is provided on one end side in the longitudinal direction of the terminal 1, but the position of the microphone 10 on the terminal 1 is not limited. The microphone 10 is an example of a voice input unit.

The speaker 20 is a device capable of outputting a sound under the control of the terminal 1. For example, the speaker 20 is provided on one end side in the longitudinal direction of the terminal 1, but the position of the speaker 20 on the terminal 1 is not limited.

The display 30 is a device capable of displaying various screens under the control of the terminal 1. For example, the display 30 is a liquid crystal display, an electroluminescence (EL) display, or the like.

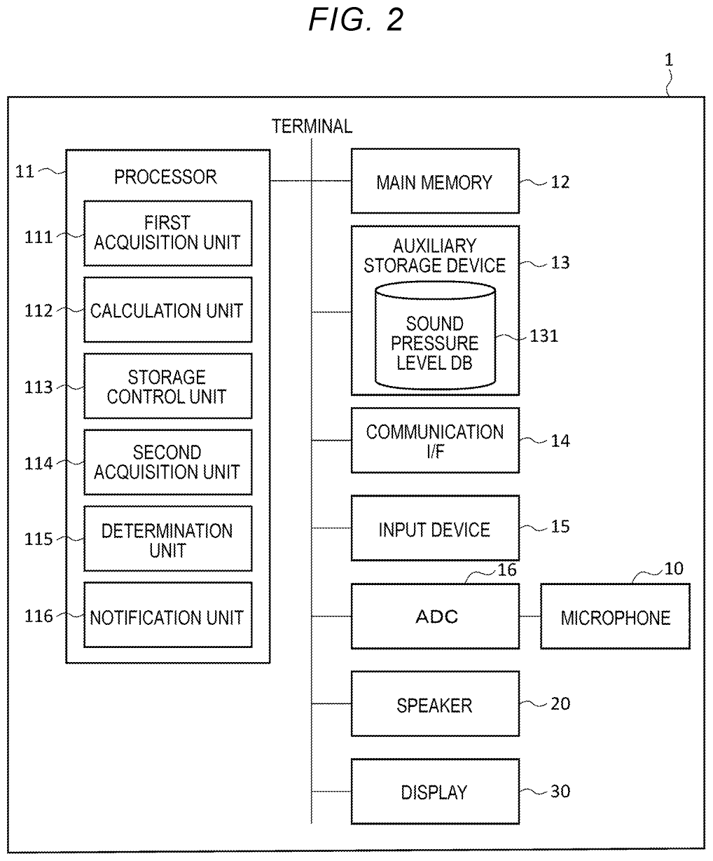

FIG. 2 is a block diagram illustrating the terminal 1.

The terminal 1 is a computer including a processor 11, a main memory 12, an auxiliary storage device 13, a communication interface 14, an input device 15, and an analog-to-digital converter 16, in addition to the microphone 10, the speaker 20, and the display 30 described above. Respective parts configuring the terminal 1 are connected so that signals can be input and output to each other. In FIG. 2, the interface is described as “I/F”. The analog-to-digital converter is described as “ADC”.

The processor 11 corresponds to a central part of the terminal 1. For example, the processor 11 is a central processing unit (CPU) but is not limited thereto. The processor 11 may be configured with various circuits. The processor 11 loads a program previously stored in the main memory 12 or the auxiliary storage device 13 into the main memory 12. The program is a program that realizes each part described later in the processor 11 of the terminal 1. The processor 11 executes various operations by executing a program loaded into the main memory 12.

The main memory 12 corresponds to a main memory part of the terminal 1. The main memory 12 includes a non-volatile memory area and a volatile memory area. The main memory 12 stores an operating system or a program in the non-volatile memory area. The main memory 12 uses the volatile memory area as a work area where data is appropriately rewritten by the processor 11. For example, the main memory 12 includes a read only memory (ROM) as the non-volatile memory area. For example, the main memory 12 includes a random access memory (RAM) as the volatile memory area.

The auxiliary storage device 13 corresponds to an auxiliary storage portion of the terminal 1. For example, the auxiliary storage device 13 is an electric erasable program read-only memory (EEPROM) (registered trademark), a hard disk drive (HDD), a solid state drive (SSD), or the like. The auxiliary storage device 13 stores the program described above, data used by the processor 11 for performing various processes, and data generated by the processes of the processor 11.

The auxiliary storage device 131 stores a sound pressure level database 131. The sound pressure level database 131 is a database that manages a sound pressure level in correlation with the time. The time is the time when the voice is input to the microphone 10. The sound pressure level is a value [dB] obtained by 20×Log₁₀(P/P₀). Here, P is an amplitude value of the voice signal. P₀ is a reference amplitude value. The sound pressure level is an example of feature data related to the voice input to the microphone 10. The feature data related to the voice is not limited to the sound pressure level as long as the feature data is an amount with which the degree of voice can be evaluated. The feature data related to the voice may be sound volume. A configuration example of the sound pressure level database 131 will be described later. In FIG. 2, the database is described as “DB”.

The communication interface 14 includes various interfaces that communicably connect the terminal 1 to other devices via a network according to a predetermined communication protocol.

The input device 15 is a device capable of inputting data or instructions to the terminal 1 by a touch operation. For example, the input device 15 is a keyboard, a touch panel, or the like.

The analog-to-digital converter 16 converts an analog voice signal (analog waveform) based on the voice input to the microphone 10 into a digital voice signal.

A hardware configuration of the terminal 1 is not limited to the configuration described above. In the terminal 1, the components described above can be omitted or changed, and new components can be added as appropriate.

Each part installed in the processor 11 described above will be described.

In the processor 11, a first acquisition unit 111, a calculation unit 112, a storage control unit 113, a second acquisition unit 114, a determination unit 115, and a notification unit 116 are installed. Each part installed in the processor 11 can be considered to be each function. Each part installed in the processor 11 can be considered to be installed in a control unit (e.g., a controller) including the processor 11 and the main memory 12.

The first acquisition unit 111 acquires a voice signal based on the voice input to the microphone 10.

The calculation unit 112 calculates a sound pressure level related to the voice input to the microphone 10 based on the voice signal acquired by the first acquisition unit 111.

The storage control unit 113 stores the sound pressure level calculated by the calculation unit 112 in the sound pressure level database 131.

The second acquisition unit 114 acquires the sound pressure level from the sound pressure level database 131.

The determination unit 115 determines whether or not the microphone 10 is blocked based on the sound pressure level acquired by the second acquisition unit 114. The fact that the microphone 10 is blocked includes not only that the entire microphone 10 is blocked, but also that a part of the microphone 10 is blocked. The fact that the microphone 10 is blocked includes not only that the user's hand or the like directly touches the terminal 1 to block the microphone 10, but also that the user's hand or the like covers the microphone 10 without directly touching the terminal 1. The sound pressure level when the microphone 10 is blocked tends to be smaller than the sound pressure level when the microphone 10 is not blocked. For that reason, the relevance exists between the blocked microphone 10 and the sound pressure level. Similarly, the relevance exists between the degree to which the microphone 10 is blocked and the sound pressure level. In a state where the microphone 10 is blocked, the accuracy of voice recognition by the terminal 1 is reduced. The fact that the microphone 10 is blocked can also be considered that the microphone 10 is occluded.

The notification unit 116 notifies that the microphone 10 is blocked, according to the determination result by the determination unit 115 indicating that the microphone 10 is blocked.

The notification unit 116 is described as being installed in the processor 11 by executing a program but is not limited thereto. The notification unit 116 notifies that the microphone 10 is blocked. For that reason, a device such as the speaker 20 or the display 30 may be an example of the notification unit 116. The notification unit 116 may be realized in cooperation with the processor 11 and a device such as the speaker 20 or the display 30 by executing a program.

A configuration example of the sound pressure level database 131 will be described.

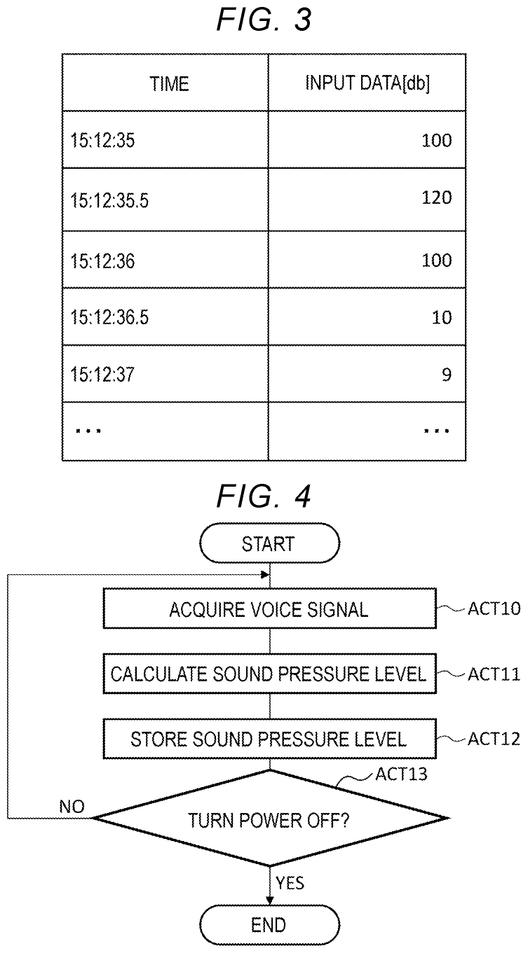

FIG. 3 is a diagram illustrating the sound pressure level database 131.

The sound pressure level database 131 includes a “time” item and an “input data” item.

The “time” item is an item for setting the time when the voice is input to the microphone 10. In the “time” item, the time at regular time intervals is set. For example, the regular time interval is an interval of 0.5 seconds but is not limited thereto. The regular time interval can be changed as appropriate. The “input data” item is the sound pressure level at the time, which is set in the “time” item. The time set in the “time” item and the sound pressure level set in the “input data” item are in correlation with each other.

The terminal 1 adds a record to the sound pressure level database 131 every time the sound pressure level is calculated at regular time intervals. The terminal 1 can update the sound pressure level database by adding the record to the sound pressure level database.

A procedure of a process by the terminal 1 will be described.

First, a sound pressure level calculation process will be described.

FIG. 4 is a flowchart illustrating a procedure of the sound pressure level calculation process.

The terminal 1 continues the sound pressure level calculation process while the terminal 1 is activated.

The first acquisition unit 111 acquires a voice signal based on the voice input to the microphone 10 (ACT 10). In ACT 10, for example, the first acquisition unit 111 acquires the voice signal from the analog-to-digital converter 16 in a time series. For example, the first acquisition unit 111 starts acquiring the voice signal based on the starting of the terminal 1.

The calculation unit 112 calculates the sound pressure level (ACT 11). In ACT 11, for example, the calculation unit 112 sequentially calculates the sound pressure levels at regular time intervals based on the voice signals sequentially acquired by the first acquisition unit 111 in ACT 10 over time.

The storage control unit 113 stores the sound pressure level in the sound pressure level database 131 (ACT 12). In ACT 12, for example, the storage control unit 113 stores the sound pressure levels calculated by the calculation unit 112 at regular time intervals in the sound pressure level database 131. The sound pressure level database 131 stores the sound pressure levels at regular time intervals in a time series.

The processor 11 determines whether or not an input instruction to turn off the power supply of the terminal 1 is detected (ACT 13). When it is determined that the processor 11 does not detect the input instruction to turn off the power supply of the terminal 1 (NO in ACT 13), the process transitions from ACT 13 to ACT 10. When it is determined that the processor 11 detects an input instruction to turn off the power supply of the terminal 1 (YES in ACT 13), the process ends.

Next, an occlusion determination process will be described.

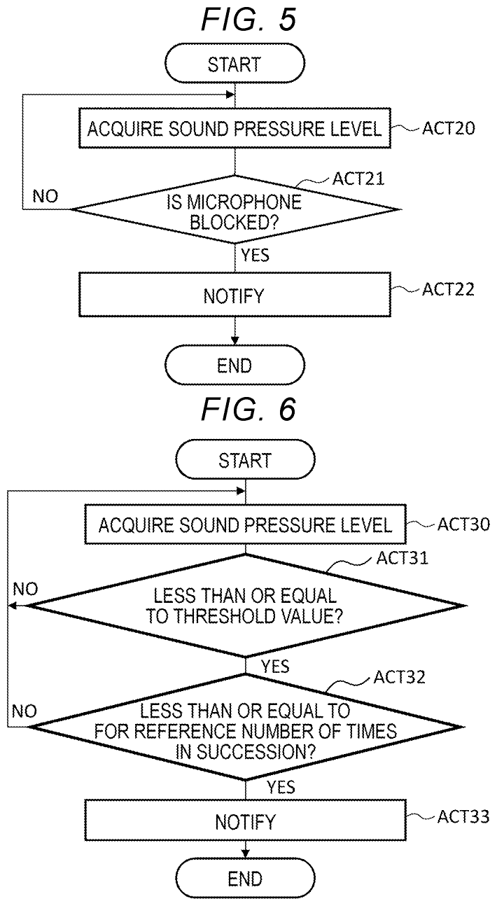

FIG. 5 is a flowchart illustrating a procedure of the occlusion determination process.

The terminal 1 continues the occlusion determination process in parallel with the sound pressure level calculation process while the terminal 1 is activated.

The second acquisition unit 114 acquires the sound pressure level from the sound pressure level database 131 (ACT 20). In ACT 20, for example, the second acquisition unit 114 can sequentially acquire the sound pressure level at the current time from the sound pressure level database 131 at regular time intervals with the passage of time. The current time is the latest time of the sound pressure level stored in the sound pressure level database 131. The current time is an example of the reference time. For example, the second acquisition unit 114 can sequentially acquire a history of the sound pressure level for a certain period retroactive from the current time from the sound pressure level database 131 at regular time intervals with the passage of time. The history of the sound pressure level includes sound pressure levels at a plurality of timings that are successive at regular time intervals in a time series. For example, the second acquisition unit 114 starts acquiring the sound pressure level based on the starting of the terminal 1.

The determination unit 115 determines whether or not the microphone 10 is blocked based on the sound pressure level acquired by the second acquisition unit 114 (ACT 21). In ACT 21, for example, the determination unit 115 can determine whether or not the microphone 10 is blocked based on the history of a set of sound pressure levels at the current time sequentially acquired by the second acquisition unit 114. For example, the determination unit 115 can determine whether or not the microphone 10 is blocked based on the history of sound pressure level acquired at one time by the second acquisition unit 114. An example of determination by the determination unit 115 in ACT 21 will be described later. The determination unit 115 generates a determination result indicating that the microphone 10 is blocked or a determination result indicating that the microphone 10 is not blocked. According to the determination result by the determination unit 115 indicating that the microphone 10 is not blocked (NO in ACT 21), the process transitions from ACT 21 to ACT 20.

According to the determination result by the determination unit 115 indicating that the microphone 10 is blocked (YES in ACT 21), the notification unit 116 notifies that the microphone 10 is blocked (ACT 22). In ACT 22, for example, the notification unit 116 can display an alert notifying that the microphone 10 is blocked on the display 30. For example, the notification unit 116 can output an alert notifying that the microphone 10 is blocked from the speaker 20. The content of the alert is not limited as long as the alert can notify the user that the microphone 10 is blocked.

As described above, the terminal 1 can determine whether or not the microphone 10 is blocked based on the feature data related to the voice input to the microphone 10. Since the relevance exists between the fact that the microphone 10 is blocked and the feature data related to voice, the terminal 1 can improve the accuracy of determining whether or not the microphone 10 is blocked.

Some typical examples of the occlusion determination process described above will be described.

First, a first occlusion determination will be described.

FIG. 6 is a flowchart illustrating a procedure of the first occlusion determination process.

The second acquisition unit 114 acquires the sound pressure level from the sound pressure level database 131 (ACT 30). In ACT 30, for example, the second acquisition unit 114 sequentially acquires the sound pressure level at the current time from the sound pressure level database 131 at regular time intervals with the passage of time.

The determination unit 115 compares the sound pressure level acquired by the second acquisition unit 114 with a first threshold value (ACT 31). In ACT 30, for example, the sound pressure levels sequentially acquired by the second acquisition unit 114 are sequentially compared with the first threshold value.

The first threshold value is a value of the sound pressure level for determining that the microphone 10 is blocked. The first threshold value is the value of the sound pressure level at which the microphone 10 is assumed to be blocked in the environment where the terminal 1 is placed. Even if the microphone 10 is similarly blocked, the sound pressure level related to the voice input to the microphone 10 is different depending on the environment where the terminal 1 is placed. For that reason, the first threshold value is different depending on the environment where the terminal 1 is placed. The first threshold value is set between the sound pressure level of 0 dB and the sound pressure level value at which the microphone 10 is assumed not to be blocked in the environment where the terminal 1 is placed. The first threshold value can be changed as appropriate.

When it is determined that the sound pressure level is not less than or equal to the first threshold value (NO in ACT 31), the process transitions from ACT 31 to ACT 30. That is, when the sound pressure level is not less than or equal to the first threshold value, the determination unit 115 determines that the microphone 10 is not blocked.

When it is determined that the sound pressure level is less than or equal to the first threshold value (YES in ACT 31), the determination unit 115 determines whether or not the sound pressure level becomes less than or equal to the first threshold value for a reference number of times in succession (ACT 32). In ACT 32, for example, the determination unit 115 determines whether or not the determination that the sound pressure level in ACT 31 is not less than or equal to the first threshold value is made for a reference number of times in succession.

The reference number of times is a number of times for determining that the microphone 10 is blocked. The reference number of times is a plurality of times. The reason why the reference number of times is preferably a plurality of times is also considered as follows. For example, when the user's hand momentarily crosses the vicinity of the microphone 10, the sound pressure level may temporarily become less than or equal to the first threshold value. In this case, the accuracy of voice recognition by the terminal 1 is not affected. On the other hand, when the sound pressure levels at a plurality of timings that are successive along a time series are all less than or equal to the first threshold value, a possibility that the user is continuously blocking the microphone 10 is high. In this case, the accuracy of voice recognition by the terminal 1 is affected. The reference number of times can be changed as appropriate.

In this way, the determination unit 115 compares the sound pressure level with the first threshold value and determines whether or not the microphone 10 is blocked based on the number of times that the sound pressure level becomes equal to or lower than the first threshold value in succession. When the sound pressure level becomes equal to or lower than the first threshold value not in succession for the reference number of times, the determination unit 115 determines that the microphone 10 is not blocked. On the other hand, when the sound pressure level becomes equal to or lower than the first threshold value in succession for the reference number of times, the determination unit 115 determines that the microphone 10 is blocked.

When the sound pressure level becomes equal to or lower than the first threshold value not in succession for the reference number of times (NO in ACT 32), the process transitions from ACT 32 to ACT 30. When the sound pressure level becomes equal to or lower than the first threshold value in succession for the reference number of times (YES in ACT 32), the notification unit 116 notifies that the microphone 10 is blocked (ACT 33). ACT 33 is the same as ACT 22 described above.

In ACT 30, an example in which the second acquisition unit 114 acquires the sound pressure level at the current time from the sound pressure level database 131 is described but the present disclosure is not limited thereto. In ACT 30, the second acquisition unit 114 may acquire a plurality of sound pressure levels corresponding to the reference number of times from the sound pressure level database 131 retroactively from the current time in a time series. In this example, the determination unit 115 compares the plurality of sound pressure levels acquired by the second acquisition unit 114 with the first threshold value. When at least one of the plurality of sound pressure levels acquired by the second acquisition unit 114 is not less than or equal to the first threshold value, the determination unit 115 determines that the microphone 10 is not blocked. On the other hand, when all of the plurality of sound pressure levels acquired by the second acquisition unit 114 are less than or equal to the first threshold value, the determination unit 115 determines that the microphone 10 is blocked.

In ACT 32, an example in which the reference number of times is set to a plurality of times is described but the present disclosure is not limited thereto. The reference number of times may be once. In this example, the determination unit 115 determines whether or not the microphone 10 is blocked, based on whether or not the sound pressure level is less than or equal to the first threshold value. When the sound pressure level is equal to or lower than the first threshold value, the determination unit 115 determines that the microphone 10 is blocked. On the other hand, when the sound pressure level is not less than or equal to the first threshold value, the determination unit 115 determines that the microphone 10 is not blocked.

In ACT 32, the determination unit 115 makes an evaluation by the reference number of times but may also make an evaluation by a period. For example, the determination unit 115 determines whether or not the microphone 10 is blocked, based on a period during which the sound pressure level becomes less than or equal to the first threshold value in succession. When the duration of the sound pressure level that becomes less than or equal to the first threshold value is less than or equal to a predetermined period, the determination unit 115 determines that the microphone 10 is not blocked. On the other hand, when the duration of the sound pressure level that becomes less than or equal to the first threshold value exceeds a predetermined period, the determination unit 115 determines that the microphone 10 is blocked. The length of the predetermined period can be changed as appropriate. With this configuration, the determination unit 115 can improve the accuracy of determining whether or not the microphone 10 is blocked by using a predetermined period in which the sound pressure level is calculated and does not depend on the length of the regular time interval. For example, as the regular time interval in which the sound pressure level is calculated becomes shorter, the time during which the sound pressure level becomes less than or equal to the first threshold value for a reference number of times in succession also becomes shorter. On the other hand, as the regular time interval in which the sound pressure level is calculated becomes longer, the time during which the sound pressure level becomes less than or equal to the first threshold value for a reference number of times in succession also becomes longer.

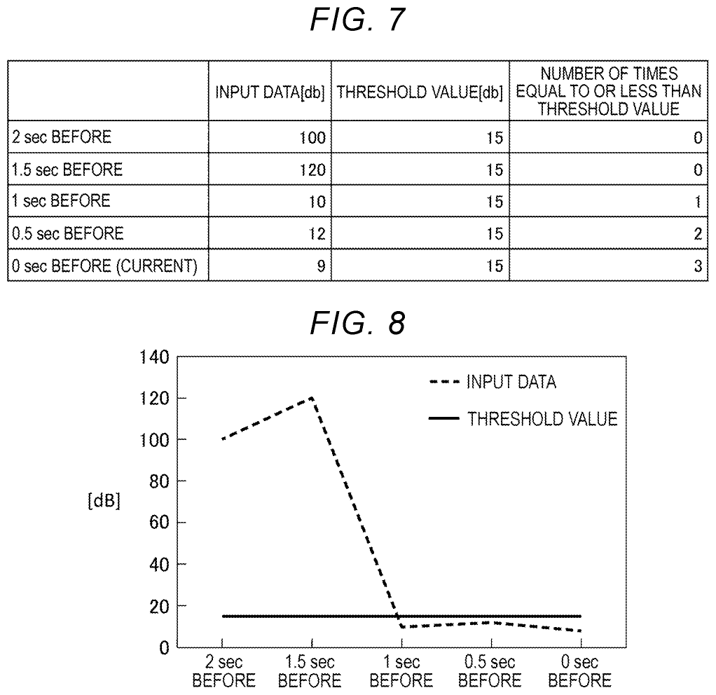

FIG. 7 is a table illustrating a first occlusion determination.

The “input data” indicates the sound pressure level at regular time intervals in a period from the current time to 2 seconds before the current time. The “threshold value” indicates the first threshold value. Here, the first threshold value is 15 dB. “Number of times less than or equal to threshold value” indicates the number of times that the sound pressure level becomes less than or equal to the first threshold value in succession. Here, the reference number of times is three times. When it is determined that the sound pressure level at the current time is less than or equal to the first threshold value, the determination unit 115 determines that the sound pressure level becomes less than or equal to the first threshold value for a reference number of times in succession. When it is determined that the sound pressure level becomes less than or equal to the first threshold value for the reference number of times in succession, the determination unit 115 determines that the microphone 10 is blocked.

FIG. 8 is a graph illustrating the first occlusion determination.

FIG. 8 illustrates the relationship shown in FIG. 7.

The horizontal axis represents the time. The vertical axis represents the sound pressure level.

The broken line is a graph of the input data. The solid line is a graph of the first threshold value.

The sound pressure level related to the voice input to the microphone 10 when the microphone 10 is not blocked is around 100 dB. On the other hand, the sound pressure level related to the voice input to the microphone 10 when the microphone 10 is blocked is around 0 dB.

As described above, in the first occlusion determination, the terminal 1 determines whether or not the microphone 10 is blocked, based on the number of times that the sound pressure level becomes equal to or lower than the first threshold value in succession. With this configuration, the terminal 1 can determine that the user is continuously blocking the microphone 10 rather than the user's hand momentarily crossing the vicinity of the microphone 10.

Next, a second occlusion determination will be described.

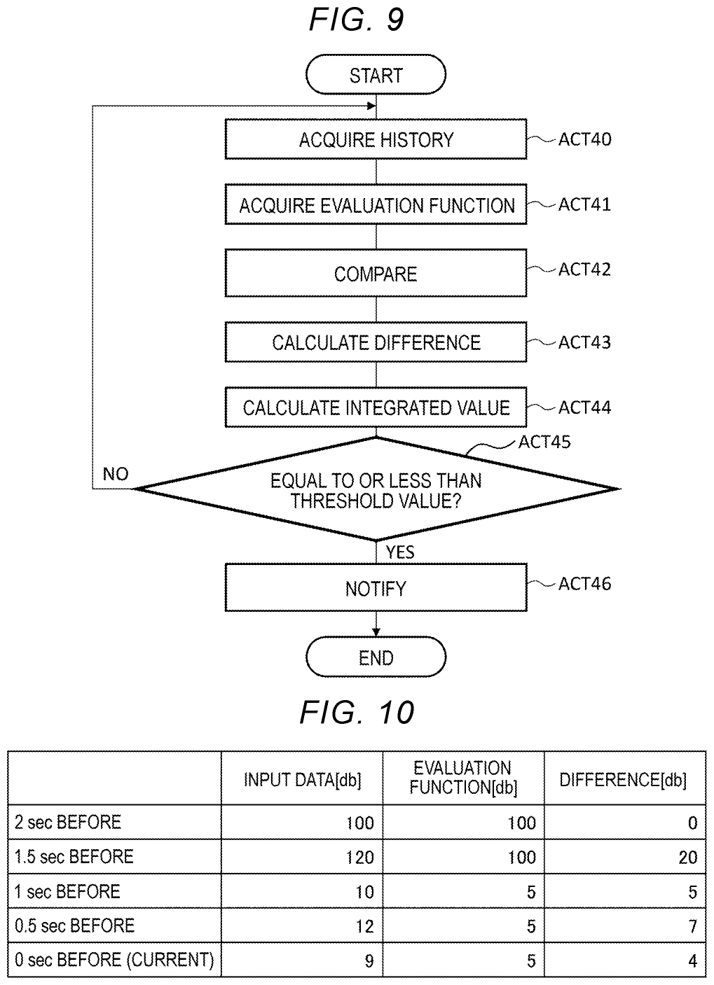

FIG. 9 is a flowchart illustrating a procedure of the second occlusion determination process.

The second acquisition unit 114 acquires a history of the sound pressure level from the sound pressure level database 131 (ACT 40). In ACT 40, for example, the second acquisition unit 114 sequentially acquires the history of the sound pressure level in a determination period from the sound pressure level database 131 at regular time intervals.

The determination period is a period during which sound pressure levels at a plurality of consecutive timings are collected at regular time intervals in order to determine whether or not the microphone 10 is blocked. The determination period is a period retroactive from the current time. The length of the determination period can be changed as appropriate. The history of the sound pressure level in the determination period is the sound pressure levels at a plurality of consecutive timings at regular time intervals in a time series in the determination period. The history of the sound pressure level in the determination period associates a plurality of times (plural timings) retroactively from the current time with the sound pressure level. For example, the determination period is 2 seconds but is not limited thereto.

The determination unit 115 acquires an evaluation function (ACT 41). In ACT 41, for example, the determination unit 115 acquires the evaluation function from the auxiliary storage device 13. In this example, the auxiliary storage device 13 stores the evaluation function regarding the determination period. The evaluation function is a function used to evaluate the history of the sound pressure level in order to determine that the microphone 10 is blocked. The evaluation function is a model that defines the transition from a state in which the microphone 10 is not blocked to a state in which the microphone 10 is blocked, by the sound pressure level that fluctuates in a time series. The evaluation function is a model in which the sound pressure level fluctuates from a high state to a low state with the passage of time.

The evaluation function regarding the determination period is a model in which a plurality of timings in the determination period are associated with the sound pressure level. The plurality of timings in the determination period are a plurality of consecutive timings at regular time intervals in a time series in the determination period. The evaluation function regarding the determination period is a model in which a plurality of consecutive timings at regular time intervals are associated with sound pressure levels in a time series at least in the determination period. The voice level related to the voice input to the microphone 10 is different depending on the environment where the terminal 1 is placed. For that reason, the evaluation function regarding the determination period is an average model suitable for comparison with the history of the sound pressure level in the environment where the terminal 1 is placed. The evaluation function regarding the determination period can be changed as appropriate. The evaluation function regarding the determination period is an example of a reference pattern that fluctuates in a time series in the determination period.

The determination unit 115 compares the history of the sound pressure level in the determination period with the evaluation function regarding the determination period (ACT 42). In ACT 42, for example, the determination unit 115 compares the sound pressure level included in the history of the sound pressure level with the sound pressure level prescribed by the evaluation function, for a plurality of timings in the determination period.

The determination unit 115 calculates a difference between the sound pressure level included in the history of the sound pressure level and the evaluation function regarding the determination period for the plurality of timings in the determination period (ACT 43). In ACT 43, for example, the determination unit 115 calculates the difference between the sound pressure level included in the history of the sound pressure level and the sound pressure level prescribed by the evaluation function for the plurality of timings. For example, when the determination period is 2 seconds and the regular time interval is 0.5 seconds, the plurality of timings in the determination period are five timings. For example, the difference is a value itself obtained by subtracting the sound pressure level prescribed by the evaluation function from the sound pressure level included in the history of the sound pressure level. The difference may be an absolute value of the value obtained by subtracting the sound pressure level prescribed by the evaluation function from the sound pressure level included in the history of the sound pressure level. The difference between the history of the sound pressure level and the evaluation function regarding the determination period for a plurality of timings in the determination period is an example of the comparison result for the determination period.

The determination unit 115 calculates an integrated value of the differences for the plurality of timings (ACT 44). In ACT 44, for example, the determination unit 115 integrates the difference for each of the plurality of timings calculated in ACT 43 to obtain the integrated value. The integrated value is related to the similarity of the history of the sound pressure level to the evaluation function. As the integrated value becomes smaller, the history of the sound pressure level tends to be highly similar to the evaluation function. That is, as the integrated value becomes smaller, the possibility that the microphone 10 is blocked during the determination period increases. On the other hand, as the integrated value becomes larger, the possibility that the microphone 10 is not continuously blocked during the determination period increases.

The determination unit 115 determines whether or not the integrated value is less than or equal to a second threshold value (ACT 45). The second threshold value is a value for determining that the microphone 10 is blocked. The second threshold value may be different depending on the environment where the terminal 1 is placed. The second threshold value can be changed as appropriate.

In this way, the determination unit 115 compares the integrated value with the second threshold value and determines whether or not the microphone 10 is blocked, based on whether or not the integrated value is less than or equal to the second threshold value. When the integrated value is less than or equal to the second threshold value, the history of the sound pressure level can be considered to be similar to the evaluation function. For that reason, when the integrated value is less than or equal to the second threshold value, the determination unit 115 determines that the microphone 10 is blocked. On the other hand, when the integrated value is not less than or equal to the second threshold value, the history of the sound pressure level can be considered not to be similar to the evaluation function. For that reason, when the integrated value is not less than or equal to the second threshold value, the determination unit 115 determines that the microphone 10 is not blocked.

When it is determined that the integrated value is not less than or equal to the second threshold value (NO in ACT 45), the process transitions from ACT 45 to ACT 40. When it is determined that the integrated value is less than or equal to the second threshold value (YES in ACT 45), the notification unit 116 notifies that the microphone 10 is blocked (ACT 46). ACT 46 is similar to ACT 22 described above.

In the example illustrated in FIG. 9, the determination unit 115 determines whether or not the microphone 10 is blocked based on whether or not the integrated value is less than or equal to the second threshold value but is not limited thereto. The determination unit 115 may determine whether or not the microphone 10 is blocked based on the integrated value, regardless of the second threshold value. For example, the determination unit 115 may determine whether or not the microphone 10 is blocked based on the transition of the integrated values calculated at regular time intervals. As described above, as the integrated value becomes smaller, the possibility that the microphone 10 is blocked during the determination period increases. On the other hand, as the integrated value becomes larger, the possibility that the microphone 10 is not continuously blocked during the determination period increases. For that reason, as a transition amount of the integrated value increases, the possibility that the microphone 10 transitions from an unblocked state to a blocked state increases. In this example, when the transition amount of the integrated value is larger than a reference amount, the determination unit 115 determines that the microphone 10 is blocked. On the other hand, when a fluctuation amount of the integrated value is less than or equal to the reference amount, the determination unit 115 determines that the microphone 10 is not blocked. The reference amount can be changed as appropriate.

In the example shown in FIG. 9, the determination unit 115 calculates the difference between the sound pressure level included in the history of the sound pressure level and the evaluation function regarding the determination period but is not limited thereto. The determination unit 115 may determine whether or not the microphone 10 is blocked based on the comparison result for the determination period, regardless of the difference. The comparison result for the determination period is a comparison between the history of the sound pressure level in the determination period and the evaluation function regarding the determination period. For example, the determination unit 115 may obtain the similarity between the graph based on the history of the sound pressure level in the determination period and the graph based on the evaluation function regarding the determination period. The similarity is an example of the comparison result for the determination period. The determination unit 115 may determine whether or not the microphone 10 is blocked based on the similarity. As the similarity increases, the possibility that the microphone 10 is blocked during the determination period.

FIG. 10 is a table illustrating a second occlusion determination.

The “input data” indicates the sound pressure levels at regular time intervals included in the history of the sound pressure level in the determination period. Here, the determination period is 2 seconds. The “evaluation function” indicates the sound pressure levels at regular time intervals prescribed by the evaluation function regarding the determination period. The evaluation function indicates a high sound pressure level (100 dB) at the timing (2 seconds before or 1.5 seconds before) away from the current time in the determination period. On the other hand, the evaluation function indicates a low sound pressure level (5 dB) at the current time and a timing close to the current time (1 second before, 0.5 seconds before, and 0 seconds before) in the determination period. The “difference” indicates the difference between the sound pressure level included in the history of the sound pressure level and the evaluation function regarding the determination period.

The determination unit 115 calculates the difference between the sound pressure level included in the history of the sound pressure level and the sound pressure level prescribed by the evaluation function for five timings at regular time intervals in the evaluation period. The determination unit 115 calculates the integrated value (36 dB) of the differences for the five timings. The determination unit 115 compares the integrated value with the second threshold value and determines whether or not the microphone 10 is blocked, based on whether or not the integrated value is less than or equal to the second threshold value

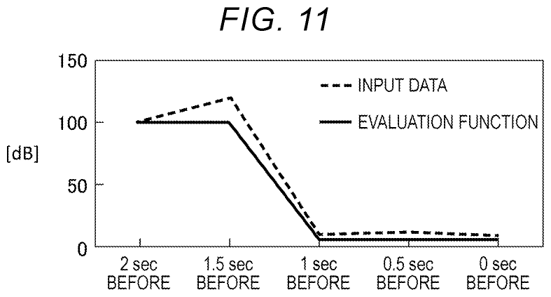

FIG. 11 is a graph illustrating the second occlusion determination.

FIG. 11 illustrates the relationship shown in FIG. 10.

The horizontal axis represents the time. The vertical axis illustrates the sound pressure level.

The broken line is a graph of the input data. The solid line is a graph of the evaluation function.

The sound pressure level related to the voice input to the microphone 10 when the microphone 10 is not blocked is around 100 dB. On the other hand, the sound pressure level related to the voice input to the microphone 10 when the microphone 10 is blocked is around 0 dB. In this way, when the microphone 10 is blocked during the determination period, the history of the sound pressure level in the determination period is similar to the evaluation function regarding the determination period.

As described above, according to the second occlusion determination, the terminal 1 determines whether or not the microphone 10 is blocked based on the comparison result for the determination period. The terminal 1 determines whether or not the microphone 10 is blocked based on the integrated value of the differences at the plurality of timings in the determination period. With this configuration, the terminal 1 can improve the accuracy of determining whether the microphone 10 is blocked during the determination period.

A modification of the second occlusion determination will be described.

The determination unit 115 compares the history of the sound pressure level in each of the plurality of determination periods having different lengths with a reference pattern that fluctuates in a time series in each of the plurality of determination periods. The determination unit 115 determines whether or not the microphone 10 is blocked, based on the comparison result for each of the plurality of determination periods.

In this example, the second acquisition unit 114 sequentially acquires histories of sound pressure levels in a plurality of determination periods having different lengths from the sound pressure level database 131 at regular time intervals. Here, an example of three determination periods of a first determination period, a second determination period, and a third determination period will be described, but the plurality of determination periods may be two or more determination periods. For example, the first determination period is 2 seconds, the second determination period is 4 seconds, and the third determination period is 6 seconds.

The determination unit 115 acquires a plurality of evaluation functions regarding the plurality of determination periods from the auxiliary storage device 13. For example, the determination unit 115 acquires the evaluation function regarding the first determination period, the evaluation function regarding the second determination period, and the evaluation function regarding the third determination period from the auxiliary storage device 13.

The determination unit 115 compares the respective histories of the sound pressure levels in the plurality of determination periods with the respective evaluation functions regarding the plurality of determination periods. For example, the determination unit 115 compares the sound pressure level included in the history of the sound pressure level with the sound pressure level prescribed by the evaluation function for a plurality of timings in the first determination period. The same applies to the second determination period and the third determination period.

The determination unit 115 calculates the difference between the sound pressure level included in the history of the sound pressure level and the evaluation function regarding the determination period for a plurality of timings in each of the plurality of determination periods. For example, the determination unit 115 calculates a difference between the sound pressure level included in the history of the sound pressure level and the sound pressure level prescribed by the evaluation function for the plurality of timings in the first determination period. The difference between the history of the sound pressure level and the evaluation function for the first determination period for the plurality of timings in the first determination period is an example of the comparison result for the first determination period. The same applies to the second determination period and the third determination period.

The determination unit 115 calculates the integrated value of the differences for the plurality of timings for each of the plurality of determination periods. For example, the determination unit 115 integrates the differences for each of the plurality of timings for the first determination period to obtain an integrated value. The same applies to the second determination period and the third determination period.

The determination unit 115 determines whether or not the integrated value is less than or equal to the second threshold value for each of the plurality of determination periods. For example, the determination unit 115 determines whether or not the integrated value is less than or equal to the second threshold value for the first determination period. The same applies to the second determination period and the third determination period. The second threshold value may be the same or different for each of the plurality of determination periods. For example, as the length of the determination period becomes longer, the second threshold value may become larger. This is because the number of the plurality of timings for obtaining the difference increases as the length of the determination period becomes longer. The number of the plurality of timings for obtaining the difference and the integrated value can become large.

The determination unit 115 determines whether or not the microphone 10 is blocked, based on whether or not the integrated value for each of the plurality of determination periods is less than or equal to the second threshold value. For example, when all the integrated values of the plurality of determination periods are less than or equal to the second threshold value, the determination unit 115 may determine that the microphone 10 is blocked. On the other hand, when the integrated value of at least one determination period among the plurality of determination periods is not less than or equal to the second threshold value, the determination unit 115 may determine that the microphone 10 is not blocked.

According to the modification, the terminal 1 can improve the accuracy of determining whether or not the microphone 10 is blocked, rather than using the comparison result for one determination period.

The transfer of the terminal is generally performed in a state where the program is stored in a main memory or an auxiliary storage device. However, the exemplary embodiment is not limited thereto, and the terminal may be transferred in a state where the program is not stored in the main memory or the auxiliary storage device. In this case, a program transferred separately from the terminal is written to a writable storage device provided in the terminal in response to the operation of the user or the like. The transfer of the program can be done by being recorded on a removable recording medium or by communication via a network. The recording medium may be in any form as long as the recording medium, such as a CD-ROM or a memory card, can store a program and the terminal can read the recording medium. A function obtained by installing or downloading the program may be one that realizes the function in cooperation with an operating system (OS) or the like inside the terminal.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing terminal comprising:
a voice input device configured to receive voice input; and
a processor configured to:
calculate feature data related to the voice input to the voice input device;
determine whether the voice input device is blocked, based on the feature data calculated; and
generate a notification that the voice input device is blocked according to a determination result indicating that the voice input device is blocked.

2. The terminal of claim 1, wherein
the processor is further configured to compare the feature data with a threshold value and determine whether the voice input device is blocked based on the number of times that the feature data is less than or equal to the threshold value in succession.

3. The terminal of claim 1, wherein
the processor is further configured to compare a history of the feature data in a determination period with a reference pattern that fluctuates in a time series in the determination period and determine whether the voice input device is blocked based on the comparison result for the determination period.

4. The terminal of claim 3, wherein
the processor is further configured to calculate a difference between the feature data and the reference pattern at a plurality of timings in the determination period and determine whether the voice input unit is blocked based on the integrated value of the differences at the plurality of timings.

5. The terminal of claim 1, wherein
the processor is further configured to compare a history of the feature data in each of a plurality of determination periods of different lengths with a reference pattern that fluctuates in a time series in each of the plurality of determination periods and determine whether the voice input unit is blocked, based on the comparison result for each of the plurality of determination periods.

6. The terminal of claim 1, wherein
the processor is further configured to:
acquire a voice signal based on the voice input from the voice input device, wherein the processor calculates a sound pressure level related to the voice input based on the voice signal acquired; and
store the sound pressure level calculated in a sound pressure level database.

7. The terminal of claim 6, wherein
the processor is further configured to acquire the sound pressure level from the sound pressure level database.

8. The terminal of claim 7, wherein
the processor is further configured to determine whether the voice input unit is blocked based on the sound pressure level acquired.

9. A method for determining an occlusion via an information processing terminal comprising:
receiving a voice input via a voice input device;
calculating feature data related to the voice input;
determining whether the voice input device is blocked, based on the feature data calculated; and
generating a notification that the voice input device is blocked according to a determination result indicating that the voice input device is blocked.

10. The terminal of claim 9, further comprising
comparing the feature data with a threshold value and determining whether the voice input device is blocked based on the number of times that the feature data is less than or equal to the threshold value in succession.

11. The terminal of claim 9, further comprising
comparing a history of the feature data in a determination period with a reference pattern that fluctuates in a time series in the determination period and determining whether the voice input device is blocked based on the comparison result for the determination period.

12. The terminal of claim 11, further comprising
calculating a difference between the feature data and the reference pattern at a plurality of timings in the determination period and determining whether the voice input device is blocked based on the integrated value of the differences at the plurality of timings.

13. The terminal of claim 9, further comprising
comparing a history of the feature data in each of a plurality of determination periods of different lengths with a reference pattern that fluctuates in a time series in each of the plurality of determination periods and determining whether the voice input device is blocked, based on the comparison result for each of the plurality of determination periods.

14. The terminal of claim 9, further comprising
acquiring a voice signal based on the voice input;
calculating a sound pressure level related to the voice input based on the voice signal acquired; and
storing the sound pressure level calculated in a sound pressure level database.

15. The terminal of claim 14, further comprising
acquiring the sound pressure level from the sound pressure level database.

16. The terminal of claim 15, further comprising
determining whether the voice input device is blocked based on the sound pressure level acquired.
